(19) United States
(12) Patent Application Publication
(10) Pub. No.: US 2011/0047212 A1
(43) Pub. Date: Feb. 24, 2011

(54) ADJUSTMENT OF A CONTACT LIST

(76) Inventors: Stephen Levy, Cary, NC (US); Kathleen McMurry, Richardson, TX (US); Steven Donovan, Dallas, TX (US); Heeral Roy, Pleasanton, CA (US); Alison Ruge, Santa Clara, CA (US); David Butt, San Jose, CA (US); Cordell Ratzlaff, Palo Alto, CA (US)

Correspondence Address: BRINKS HOFER GILSON & LIONE, P.O. BOX 10395, CHICAGO, IL, 60610, US

(21) Appl. No.: 12/544,641

(22) Filed: Aug. 20, 2009

(51) Int. Cl. G06F 3/048; G06F 15/16; G06F 17/30

(52) U.S. Cl. 709/204; 715/821; 707/E17.005

(57) ABSTRACT

A method for adjusting a contact list is provided. The method includes obtaining a contact list having a list of one or more media types for a contact. Contact data is obtained. The contact data defines an accessibility of the contact to the one or more media types. The method may include determining an accessibility level for reaching the contact using the one or more media types based on the contact data. The accessibility level may be a probability of reaching the contact using the one or more media types. The contact list may be adjusted based on the determined accessibility level.

### FIELD OF TECHNOLOGY

The present embodiments relate to adjustment of a contact list based on data relating to a contact.

### BACKGROUND

As technology has advanced, contact lists have been used to indicate operating states of certain technology. For example, instant messaging services provide contact lists, such as buddy lists or friend lists, which indicate whether a contact's instant messaging service is active or not active, being used or not being used, or available or not available. The operating state of the technology, however, is limited. The operating state is unable to indicate when a contact is available to use the technology. For example, an instant messaging service may indicate that a contact is using the instant messaging service when actually a person other than the contact is using the instant messaging service.

### BRIEF DESCRIPTION OF THE DRAWINGS

FIG. 1 illustrates one embodiment of a system for adjusting a contact list; and

FIG. 2 illustrates one embodiment of a method for adjusting a contact list.

### DETAILED DESCRIPTION

The present embodiments relate to adjusting a contact list based on contact data, such as data relating to the contact's historical tendencies, usage, location, locomotion, preferences, calendar events, or other data defining the availability of the contact via a media and/or media type. The contact list may be adjusted to reflect an accessibility level. The accessibility level indicating whether the contact is accessible to a media and/or media type. This may increase the chances that a user, who is attempting to communicate with a contact, will be able to connect with the desired contact.

Media may include voice, video, text, or graphics. Media types may include a media device, media service, or both a media device and a media service. Exemplary media devices are cell phones, office phones, personal computers, and personal digital assistants (PDA). Exemplary media services are instant messaging services, video conferencing services, blogging services, or social networking services.

Context data may be gathered. Context data may include contact data, media type data, both contact data and media type data, circumstantial data, or a combination thereof. Contact data may include data defining the availability of the contact via a media and/or media type, such as the contact's historical tendencies, usage, location, locomotion, preferences, schedules, or calendar events. Media type data may include data about a media type, such as an operating state, on/off state, log-in state, usage, location, or locomotion of the media type. Circumstantial data may include data relating to other circumstances surrounding the contact, such as time of day, predefined rules, or other data.

A level of accessing a contact via a media and/or media type (hereinafter, “accessibility level”) may be determined based on context data. The accessibility level may be a likelihood or probability. The accessibility level may be used to indicate whether a contact is available to use a media and/or media type. In one embodiment, only contact data is used to determine the accessibility level. Determining the accessibility level based on contact data increases, relative to using only media type data, the chances of determining whether a contact may actually be reached using the media type. For example, the accessibility level may indicate that the contact is unavailable based on a calendar event. In another embodiment, in addition to contact data, media type data and/or circumstantial data may be taken into account when determining the accessibility level. For example, the accessibility level may take into account the contact's location relative to an active media type, instead of merely indicating that a contact is available when a media type is active.

In one embodiment, the accessibility level may be an increased level or a decreased level. An increased level may indicate that the contact has the ability to or will access a media and/or media type. Whereas, a decreased level may indicate that the contact does not have the ability to or will not access a media and/or a media type. Other levels are possible.

The contact list may be adjusted to reflect the accessibility level. Adjusting the contact list may include adjusting a media icon and/or media type icon in the contact list. The color, size, description, shading, and/or shape of the media icon and/or media type icon may be adjusted. For example, a media type icon may change back-and-forth between the color red and the color green as the accessibility level changes from a decreased level to an increased level or relative to a threshold level.

In one aspect, a method for adjusting a contact list is provided. The method includes obtaining a contact list having a list of one or more media types for a contact. Contact data is obtained. The contact data defines an accessibility of the contact to the one or more media types. The method may include determining an accessibility level for reaching the contact using the one or more media types based on the contact data. The accessibility level may be a probability of reaching the contact using the one or more media types. The contact list may be adjusted based on the determined accessibility level.

In a second aspect, a system for adjusting a contact list is provided. The system may include an input and a processor. The input is configured to obtain contact data. The contact data may define accessibility of the contact to a media type. The processor may be operable to determine a level associated with an ability to access a contact using the media type based on the contact data. The level may be determined by comparing the contact data to a set of policies, such as hierarchical policies. The processor may be operable to adjust a contact list based on the level associated with the ability to access the contact using the media type.

In a third aspect, an availability server is provided. The availability server may include a processor configured to execute instructions and a memory coupled with the processor. The memory may be computer readable storage media. The memory may store instructions that may be executed to obtain a contact list having a list of one or more media or media types associated with a contact; obtain contact data, the contact data defining an accessibility of the contact to the one or more media types; determine a level associated with an ability to access a contact using the media type based on the contact data; and adjust the list of media types based on the determined level.

In one illustration, which will be referred to herein as “the illustration above,” John is attempting to communicate with Mary. Using his personal computer, John may access a contact list that includes a listing of the media and/or media types used by Mary. In this illustration, Mary may communicate with audio. The audio media types include an office telephone and a cellular telephone. As an exemplary illustration, Mary may be driving in her car and carrying her cellular telephone. One embodiment relates to (1) determining that there is a reduced level that Mary is accessible via her office phone based on Mary's location (e.g., because Mary is no longer in her office) and determining that there is an increased level that Mary is accessible via her cellular telephone (e.g., because Mary is able to answer cellular telephone calls while driving) and (2) automatically adjusting John's contact list to indicate that Mary is not accessible via her office phone but is accessible via her cellular telephone. For example, in John's contact list, an office phone icon may be changed to red and a cellular phone icon may be changed to green.

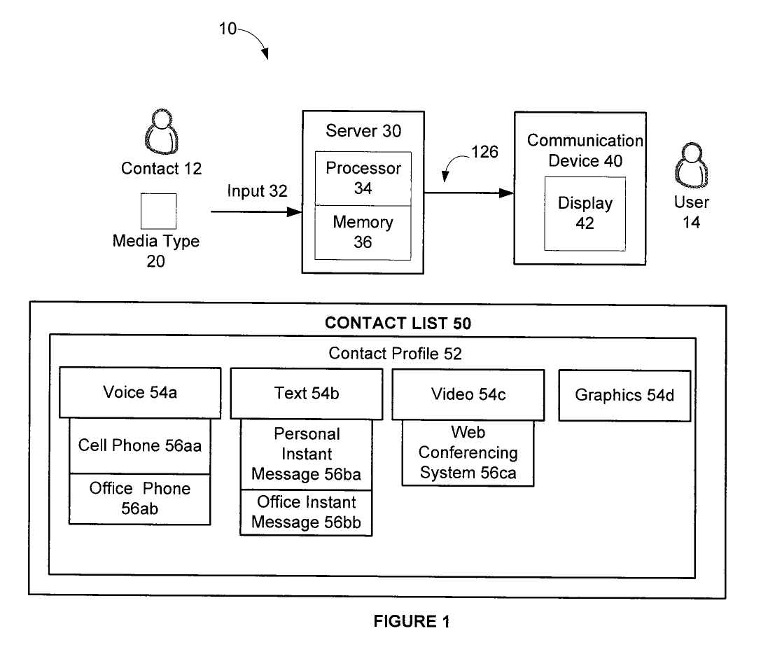

FIG. 1 shows a system 10 for dynamically adjusting a contact list. The system 10 may include one or more media types 20, a server 30, and one or more communication devices 40 (hereinafter communication device 40). The server 30 may be coupled with the one or more media types 20 and/or the communication device 40. As used herein, “coupled with” includes directly connected to or indirectly connected through one or more intermediary components. The one or more intermediary components may be wireless or wired networks, hardware and/or software components. In alternative embodiments, the system 10 may include additional, different, or fewer components.

One or more contacts 12 (hereinafter, contact 12) may operate, manage, or own all, some, or none of the one or more media types 20. The contact 12 may be known to a user 14. The user 14 may operate the communication device 40. The contact 12 and the user 14 may be human-beings, electronic devices, computer programs configured to be executed on an electronic device, or other entities. The user 14 may attempt to communicate with, reach, or access the contact 12 via the one or more media types 20. In the illustration above, John is the user 14 and Mary is the contact 12.

The system 10 may be used to dynamically adjust a contact list 50. The contact list 50 may be an electronic list used with or as part of a personal computer (e.g., desktop computer, laptop computer), mobile device (e.g., cellular telephone, personal digital assistant), time management program (e.g., Microsoft Outlook® sold by Microsoft Inc.), social network service (e.g., Facebook®), mobile music device (e.g., iTouch® sold by Apple, Inc.) or other application or device that keeps track of contacts. The contact list 50 may be a contact record, historical record, conversation window, or other interface displaying availability of a contact to a media and/or media type.

The contact list 50 may include one or more contact profiles 52 (hereinafter, contact profile 52) that profile a contact 12. The contact profile 52 may be an icon representing the contact 12. As used herein, an “icon” may be an emblem, symbol, textual description, graphical symbol, image, pictorial representation, layer, tier, or a sign whose form suggests a meaning or type of object represented. The icons may represent a contact, media, or media type. For example, a graphic of a telephone or telephone number may represent an office phone. In another example, a picture of a contact may be included the contact profile 52.

The contact list 50 may be tiered and/or interactive. In one embodiment, the contact list 50 may include different layers. One, some, or all of the layers may be displayed at the same time. For example, the contact list 50 may include one or more contact profiles 52. One of the contact profile 52 icons may be selected, for example, by clicking on, scrolling over, tapping, or otherwise selecting the contact profile 52. Once a contact profile 52 is selected, a listing of media icons 54 for the contact represented by the contact profile 52 may be displayed. One of the media icons 54 may be selected. Once a media icon 54 is selected, one or more media type icons 56 may be displayed for the contact 12. For example, as shown in FIG. 1, when the voice icon 54a is selected, a cell phone icon 56aa and office phone icon 56ab may be displayed. The user 14 may use the communication device 40 to select. Alternatively, or additionally, the communication device 40 may select. Selection may be automatic.

In an alternative embodiment, the contact list 50 may include a single layer. In other words, the contact profile may include a single layer of media icons 54 and/or media type icons 55. The media icons 54 and/or media type icons 55 may be directly displayed without selecting the contact profile.

A media icon may include a representation of a media used by the contact and/or the contact's accessibility to communicate using a media. A media type icon may include a representation of a media type 20 used by the contact 12 and/or the contact's accessibility to communicate using the media type 20.

The media type 20 may be a media device, media service, or both a media device and service. Exemplary media devices are cell phones, office phones, personal computers, and personal digital assistants (PDA). Exemplary media services are instant messaging services, video conferencing services, blogging services, or social networking services. The media type 20 may be used to communicate with the contact 12. The media type 20 may be coupled with and/or registered with the server 30. In the illustration above, Mary's office phone and cellular phone are media types 20.

The media type 20 may be a media type registered to, available to, or otherwise associated with the contact 12. For example, registering the media type may include entering the contact's name in a register, recording the contact 12 as the owner or user of the media type, officially or unofficially linking the contact 12 to the media type. In another example, the media type 20 may be a publically shared media type, such as a phone in a conference room where the contact 12 is currently present.

The contact 12 may communicate using one or more media types 20. The one or more media types 20 may be the same or different media types. The contact 12 may use a plurality of the same media types 20. For example, as shown in FIG. 1, the contact 12 may communicate with a personal instant messaging service 56ba and an office instant messaging service 56bb. In another example, contact 12 may use a plurality of different media types 20, such as an email messaging service and voicemail messaging service.

The contact list may be managed, maintained, or supported by a server 30. The server 30 may be a personal computer, network device, or server, such as a central server, intermediary server, network server, aggregating server, or other server for adjusting a contact list 50. In one example, the server 30 is a central server that may assist in gathering context data, aggregating context data, determining whether a contact 12 is accessible via one or more media types 20, and adjusting the contact list 50 based on the context data. The central server may distribute the adjusted contact list 50 to the communication device 40. Alternatively, the central server may transmit instructions for adjusting a contact list 50. The contact list 50 may be stored on the communication device 40. The instructions may be executed to adjust the contact list 50.

The server 30 may include an input 32, a processor 34, and a memory 36. The processor 34 may be communicatively coupled with the input 32 and the memory 36. Additional, different, or fewer components may be provided.

The input 32 may be a user input, network interface, external storage, external storage, other input device, or other method of gathering information about the media device, media service, or context data associated with the contact. For example, the input 32 is a mouse, keyboard, track ball, touch screen, joystick, touch pad, buttons, knobs, sliders, combinations thereof, or other now known or later developed user input device. The user input may operate as part of a user interface. For example, one or more buttons are displayed on a display. The user input is used to control a pointer for selection and activation of the functions associated with the buttons. Alternatively, hard coded or fixed buttons may be used. As another example, the input 32 is a hard-wired or wireless network interface. A universal asynchronous receiver/transmitter (UART), a parallel digital interface, a software interface, Ethernet, or any combination of known or later developed software and hardware interfaces may be used. The network interface may be linked to various types of networks, including a local area network (LAN), a wide area network (WAN), an intranet, a virtual private network (VPN), and the Internet.

The input 32 may be used to gather context data. Gathering context data may include requesting, receiving, accessing a memory, reading a clock, receiving information from a global positioning system, receiving information on whether a media type is being used, receiving location information, receiving locomotion information, etc.

The server 30 may determine, based on context data, a level of accessing the contact 12 via a media and/or media type 20. Accessing the contact 12 may take into account whether the contact 12 has the ability to access the media and/or media type and/or whether the contact 12 will choose to access the media and/or media type.

In one embodiment, the server 30 uses contact data to determine the level of accessing the contact 12. For example, the level of accessing the contact 12 may be determined based on the contact's actual physical location (e.g., geo-location). In another embodiment, the server 30 uses the contact's schedule to determine the level of accessing the contact 12. Additional data may be used in combination with the contact data to determine the accessibility level. For example, the level of accessing the contact 12 may be determined based on the contact's actual physical location relative to the actual physical location of an active media type. As used herein, the term “based on” may include as a function, depending on, as a result of, or as a calculation of.

The level of accessing the contact 12 via a media and/or media type 20 may be a probability that a contact 12 may be reached via a media and/or media type when a user 14 attempts to reach the contact 12 using that particular media and/or media type. The level may be expressed as a range (e.g., reduced level, medium level, or increased level). However, in other embodiments, the level may be expressed as a probability, percentage, sliding bar, up arrow, down arrow, other description, or other mathematical or non-mathematical indicator.

In order to determine the level of accessing the contact 12, the server 30 may use one or more policies. The policies may be a set of one or more rules and definitions. The one or more policies may be manually or automatically defined by a user, contact, system administrator, server 30, or other electronic policy system. The one or more policies may be weighted relative to each other. The policies may be hierarchical in nature. An actual probability, based on past examples or other information, may be used. In other embodiments, the level is based on rules or thresholds set to represent differences in chance rather than an actual level.

The server 30 may compare context data to one or more policies to determine the level of accessing a contact 12 via a media and/or media type 20. In one example, a contact 12 may swipe a company badge to exit Building X. The server 30 may determine that the contact 12 is not in Building X. The server 30 may receive entrance/exit information from a security system monitoring the company badge. This contact data (i.e., that the contact 12 is not in Building X) may be compared to the hierarchy of policies. One of the policies may be: “If not in Building X, then there is a reduced level of the contact 12 accessing the office phone and instant messenger service.” In other embodiments, a contact's global positioning system (GPS) enabled mobile device may be used to determine the contact's location. The contact's location may be compared to one or more policies.

In another example, a contact 12 may update an electronic calendar to indicate that from 9:00-10:00 am the contact 12 will be in conference room A for a status meeting. The server 30 may receive the calendar information from a server supporting the electronic server. The context data indicating that contact 12 will be in conference room A from 9:00-10:00 am may be compared to the hierarchy of policies. One of the policies may be: “If in Conference Room A, there is an increased level of the contact 12 accessing the conference room telephone located in Conference Room A.” As a result, the server 30 may associate an increased level with the conference room telephone from 9:00-10:00 am.

A combination of policies may be used by the server 30. Policies may be aggregated to form an aggregated level. The aggregated level may be determined by determining the level with the greatest possibility of being correct. For example, in one embodiment, if two (2) policies indicate that there is a reduced level for a media type and one (1) policy indicates that there is an increased level for the media type, then the server 30 may associate a reduced level of accessing the contact 12 using the media type. Since two policies indicate a reduced level, there is a greater possibility of the level being a reduced level. Accordingly, the aggregated level is a reduced level.

In another embodiment, the policies may be weighted. One policy may be given more weight than another policy. Weights may include rankings or preference. A policy with a greater weight may override a policy with a lower weight. The weightings of the policies may be combined. For example, three policies may be used to determine the level of accessing a contact 12 via an office phone. The first policy may have a weight of “10”, the second policy may have a weight of “4”, and the third policy may have a weight of “5”. The first policy may indicate an increased level of accessing the contact 12 via the office phone; however, the second and third policies may indicate that a decreased level. The weightings may be aggregated to determine the aggregated level. In this example, the first policy may outweigh the aggregation of the second and third policies (i.e., 10 is greater than 7). Accordingly, the aggregated level is an increased level.

The server 30 may be operable to dynamically adjust the contact list 50 based on the level or aggregated level of accessing the contact 12 via a media and/or media type. Dynamically adjusting the list of registered media types may include adding one or more media icons 54 and/or media type icons 56, removing one or more media icons 54 and/or media type icons 56, changing the appearance of a media icon 54, changing the appearance of a media type icon 56, or a combination thereof.

One or more media icons 54 and/or media type icons 56 may be added to the contact list 50 based on the level of accessing a contact 12. For example, a video conferencing service icon may be removed when there is a reduced level of accessing the contact 12 via the video conferencing service.

Changing the appearance of a contact profile 52, media icon 54 and/or a media type icon 56 may include changing the color, size, description, shading, and/or shape of the icons. Changing the appearance may include changing the background, foreground, text, shading, filling, transparency, or other feature. In one embodiment, a background color may be used to represent the level of accessing the contact 12 using a particular media type 20. The background color of the media type icon 56 may be changed from a first color to a second color. Any color may be used. Red, green, yellow, orange, pink, blue, or any other color may be used. In one example, the background color of the media type icon 56 may be red when there is a reduced level of accessing the contact 12 via the particular media type 20. The background color of the media type icon 56 may be yellow when the media type 20 is active but there is a reduced level of accessing the contact 12. A media type icon 220 may be green when there is an increased level of accessing the contact 12.

The appearance of the contact profile 52 may be adjusted based on the level of accessing the contact 12 using one or more media and/or media types 20. The appearance of the contact profile 52 may be adjusted to reflect the overall accessibility of the contact 12. The appearance of the contact profile 52 may be based on the level of accessing the contact 12 using a media and/or media type 20. For example, when there is a reduced level of accessing the contact 12 using all of the media types 20, the appearance of the contact profile 12 may be adjusted to indicate that there is a reduced level of accessing the contact 12. For example, the color of the contact profile 12 may be changed to red.

The server 30 may adjust the contact list 50 dynamically, periodically, continuously, or as a rule. For example, the server 30 may adjust the contact list 50 each time predefined context data changes, such as when the server 30 detects an operation status change or availability change. In another example, the server 30 may adjust the contact list 50 when the user 14 accesses the contact list 50.

The following examples illustrate changing the appearance of a contact profile 52, media icon 54, and/or media type icon 56.

Example 1: If the contact 12 is logged out of all instant messaging types 56ba and all email messaging services 56bb, then the media icon 54b for Text is red even when the contact profile 52 is Green. The contact profile 52 may be Green when the contact 12 is available (working hours, not busy).

Example 2: If the contact 12 has forwarded an office phone to voicemail, then the media icon 54a for Voice is Red even if the contact 12 is Available (e.g., available hours, not busy, sitting on his desk).

Example 3: If the contact 12 is not logged in or connected to a video client, then the media icon 54c for video is red, even when the contact 12 is available (e.g., available hours, not busy, sitting on his desk).

Example 4: If the contact 12 is logged into an instant messaging client but is busy on the phone or in a meeting, then the media icon 54b for Text is yellow because the contact 12 is busy and the response to a message might be slow.

Example 5: If the contact 12 is on the office phone or is occupied interacting with someone such as in a meeting, then the media icon 54a for Voice is yellow because the contact 12 is unable to answer a phone call and there might be a slow or no response.

Example 6: If the contact 12 is logged into an office phone 56ab and an office instant messaging client 56bb but is in non-working hours (e.g., as specified by the contact 12), then the media icon 54a for Voice and the media icon 54b for Text are red because the contact 12 is unavailable and gone home for the day.

Example 7: If the contact 12 is logged into a phone and IM client but is in a Do not disturb mode, then his accessibility via Voice, Text and Video is Red because the contact 12 does not want to be disturbed.

Example 8: If the contact 12 is logged into an office phone 56aa and is not “On the Phone” or “In a Meeting,” then the media icon 54 for Voice may be green.

Example 9: If the contact 12 is logged into an office instant message client 56bb and is not busy in a meeting or on the phone, then the media icon 54 for Text is green.

Example 10: If the contact 12 is logged into the phone or an instant messaging service but has not touched any of his devices for the past “x” minutes, then the media icon 54 for Voice and Text is yellow as the contact 12 might have gone home for the day and may or may not answer any incoming communications.

Example 11: If the contact 12 is not busy in a meeting or on the phone, then the media icon 54a for Voice is green.

In other embodiments, the size of the contact profile 52, media icon 54, and/or media type icon 56 may be changed to indicate the level of the contact 12 being able to communicate via media and/or media type. Alternatively, a textual or graphical description may be changed.

The media icon 54 may be adjusted based on the one or more corresponding media type icons 56. For example, when all of the media types related to a media have a decreased level associated with the corresponding media type icons 56, the media icon 54 for that media may have a decreased level. When one or more of the media types related to a media have an increased level associated with the corresponding media type icon 56, the media icon 54 may have an increased level.

Once the contact list 50 is adjusted, the server 30 may transmit the contact list 50 to the communication device 40. The contact list 50 may be transmitted periodically, continuously, or as a predefined rule. In an alternative embodiment, the server 30 may transmit instructions to the communication device 40. The instructions may instruct the communication device 40 how to adjust the list 50.

The acts performed by the server 30 may be performed by a processor 34, memory 36, or a combination thereof. The processor 34 may be a general processor, digital signal processor, application specific integrated circuit, field programmable gate array, analog circuits, digital circuit, combinations thereof, or other now known or later developed processors. The processor 34 may be a single device or a combination of devices, such as associated with a network or distributed processing. Any of various processing strategies may be used, such as multi-processing, multi-tasking, parallel processing, or the like. Processing may be local, as opposed to remote. The processor 34 may be responsive to instructions stored as part of software, hardware, integrated circuits, firmware, micro-code or the like.

The memory 36 may be computer readable storage media. The computer readable storage media may include various types of volatile and non-volatile storage media, including but not limited to random access memory, read-only memory, programmable read-only memory, electrically programmable read-only memory, electrically erasable read-only memory, flash memory, magnetic tape or disk, optical media and the like. The memory 36 may be a single device or a combination of devices. The memory 36 may be adjacent to, part of, networked with, programmed with, and/or remote from the processor 34. The memory 36 may store data representing instructions executable by the programmed processor 34. The processor 34 may be programmed with and execute the instructions. The functions, processes, acts, methods or tasks illustrated in the figures or described herein may be performed by the programmed processor executing the instructions stored in the memory. The functions, acts, processes, methods or tasks are independent of the particular type of instructions set, storage media, processor or processing strategy and may be performed by software, hardware, integrated circuits, firm ware, micro-code and the like, operating alone or in combination.

The communication device 40 may be a personal computer, mobile device, cellular phone, personal digital assistant, mobile media player, server, router, endpoint, or other device for display a dynamically adjusted list of registered media types. The display 42 may be a monitor, liquid crystal display (LCD), digital or analog display, or other display. The display may be used for viewing the list of media types. The server 30 may be coupled with the communication device 40 across network 126. The network 126 may include a network segment, communication channel, Internet, Intranet, wireless connection, wired connection, single connection, series of connections, or a combination thereof. In the illustration above, John's personal computer is the communication device 40.

The communication device 40 may be operable to display the list 50. The list 50 may be displayed as part of or independently of a communication interface. For example, the dynamically adjusted list may be integrated with a feature that provides access to user information, such as contact information, communication information, etc. In another example, the dynamically adjusted list may be stored in memory for display at a later time.

Displaying the dynamically adjusted list of registered media types may include displaying a media type icon for each media type listed in the dynamically adjusted list of registered media types. The media type icon may represent the media types. When displayed, the dynamically adjusted list of registered media types may include the media type icons, textual descriptions of the media types, graphical descriptions of the media types, other descriptions of the media types in the dynamically adjusted list, or a combination thereof.

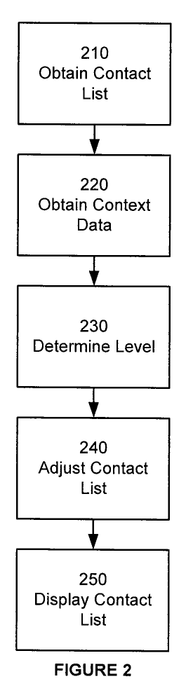

FIG. 2 illustrates a method 200 for dynamically adjusting a contact list. All, some, or none of the components of FIG. 1 may implement the acts of method 200. The acts may be performed in the order shown or a different order. For example, acts 220 and 230 may be performed before act 210. The method 200 may be performed by a server or communication device. Other devices may also perform the method 200.

The method 200 may include obtaining a list of one or more media types registered on behalf of a contact 12, obtaining context data, determining an accessibility level for each of the one or more media types, determining whether the accessibility level is an increased level or a reduced level, adjusting the list of media types based on whether the accessibility level is an increased level or a reduced level, the contact list may be displayed.

In act 210, a server and/or a communication device may obtain a contact list. The contact list may include a contact profile icon, media icon, and/or a media type icon. The contact profile icon may represent an overall accessibility of a contact. The media icons may represent accessibility of a contact using a particular media, such as voice, text, video, or graphics. The media type icons may represent accessibility of the contact using one or more media types, such as media devices and/or media services.

Obtaining the contact list may include receiving, requesting, or accessing all or some of the contact list. The contact list may be received from one or more media types, servers supporting the media types, communication devices, remote devices, memory, third party databases, or other devices or services. The contact list may be received from one or more places, devices, or databases. As a result, obtaining the contact list may also include combining data into the contact list.

In act 220, a server and/or a communication device may obtain context data. The context data may include contact data, media type data, and/or circumstantial data. Obtaining the context data may include receiving, requesting, or accessing all or some of the context data. The context data may be received from one or more media types, servers supporting the media types, communication devices, remote devices, memory, third party databases, or other devices or services. The context data may be received from one or more places, devices, or databases. As a result, obtaining the context data may also include combining context data.

In act 230, the accessibility level indicating a probability of accessing the contact 12 for each of one or more media types and/or a probability of accessing the contact 12 for each of one or more media types as well as the overall probability of accessing contact 12 at all is determined. The accessibility level may be determined based on the context data. Weights, rules, policies, historical probabilities, and/or other functions may be used to determine the accessibility level.

In act 240, the server and/or the communication device may adjust the contact list based on the accessibility level. Adjusting may include changing the appearance of a contact profile icon, one or more media icons, one or more media type icons, or a combination thereof.

Changing the appearance may include changing color, size, description, shading, and/or shape. For example, in one embodiment, the color of a media type icon may be changed based on the contact's accessibility to the media type. The color may be changed from a first color to a second color when there is a change in the accessibility, for example, from a reduced level of accessing the media type to an increased level of accessing the media type. In another embodiment, the shape may be changed to reflect a change in accessibility. In yet another embodiment, the color and shape may be changed. In one example, a telephone number for a contact is treated as the icon. The telephone number is altered in size, color, or other appearance characteristic (e.g., flashing).

The appearance may be changed to indicate accessibility of a contact to a media and/or media type. Alternatively, or additionally, the appearance of the contact profile icon may indicate accessibility to a contact using one, some, or all of the media types. For example, when there is a reduced level for all of the media types in the contact list, the appearance of the contact profile icon may be adjusted to indicate that there is a reduced level of accessing the contact. However, in another example, when there is an increased level of accessing of a contact using one or more media types, the contact profile icon may be adjusted to indicate that there is an increased level of accessing the contact.

In act 250, the contact list may be displayed. The displayed contact list may illustrate or show the adjustments. As a result, the contact's accessibility to the one or more media types may be displayed. The contact list may be displayed on a communication device having a display, monitor, or screen. A user may view the contact list on the communication device. Once viewed, the user has an increased probability of choosing a media type that the contact will have access to because of the displayed adjustments. Accordingly, the amount of time spent trying to access the contact is reduced. Additionally, the cost in sending messages, placing calls, and time checking messages is reduced.

While the invention has been described above by reference to various embodiments, it should be understood that many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention.

1. A method for adjusting a contact list, the method comprising:
obtaining a contact list having a list of one or more media types assigned for a contact;
obtaining contact data, the contact data defining an accessibility of the contact to the one or more media types;
determining an accessibility level for reaching the contact using the one or more media types based on the contact data, the accessibility level indicating a probability of reaching the contact using the one or more media types; and
adjusting the contact list based on the determined accessibility level.

2. The method as claimed in claim 1, wherein adjusting includes changing the appearance of one or more media icons or one or more media type icons, the media icons representing an overall state of a media and the media type icons representing the one or more media types.

3. The method as claimed in claim 2, wherein changing the appearance includes changing a color of the one or more media icons or one or more media type icons from a first color to a second color when there is a change in the accessibility level, the first color being different than the second color.

4. The method as claimed in claim 1, wherein determining the accessibility level includes comparing contact data to a set of hierarchical policies.

5. The method as claimed in claim 1, wherein the accessibility level is a reduced level, increased level, or medium level of accessing the contact.

6. The method as claimed in claim 1, wherein the contact data includes data about the location of the contact or data about a schedule of the contact.

7. The method as claimed in claim 1, further comprising displaying the contact list on a communication device having a display, monitor, or screen.

8. A system for adjusting contact information, the system comprising:
an input configured to obtain contact data, the contact data defining an accessibility of a contact to a media type; and
a processor that is operable adjust a level associated with an ability to access the contact using the media type based on the contact data, the level may be determined by comparing the contact data to a set of policies,
wherein the processor is operable to adjust a contact list based on the level associated with the ability to access the contact using the media type.

9. The system as claimed in claim 8, wherein the processor is operable to output the contact list to a communication device having a display.

10. The system as claimed in claim 8, wherein the level is a level of accessing the contact via a media or media type.

11. The system as claimed in claim 10, wherein an appearance of a contact profile may be adjusted to reflect the level of accessing the contact.

12. The system as claimed in claim 8, wherein an appearance of a media icon or media type icon may be adjusted to reflect the level associated with the ability to access the contact using the media type.

13. The system as claimed in claim 12, wherein a background color of the media icon or media type icon may be adjusted.

14. The system as claimed in claim 12, wherein a shape of the media icon or media type icon may be adjusted.

15. Computer readable storage media storing instructions that may be executed by a programmed processor, the instructions being executed to:
obtain a contact list having a list of one or more media or media types associated with a contact;
obtain a current accessibility of the contact to the one or more media types based on contact data; and
alter the contact list based on the current accessibility of the contact with the one or more media types.

16. The computer readable storage media as claimed in claim 15, wherein the instructions may be executed to change an appearance of one or more media icons and one or more media type icons, media icons representing an overall state of a media and the media type icons representing the one or more media types.

17. The computer readable storage media as claimed in claim 16, wherein the instructions may be executed to change a color of one or more media icons and one or more media type icons from a first color to a second color when there is a change in the accessibility level.

18. The computer readable storage media as claimed in claim 15, wherein the instructions may be executed to:
determine a first score for a first media type in the one or more media types; and
compare the first score to a level threshold, the level threshold indicating whether the accessibility level is an increased level or a reduced level.

19. The computer readable storage media as claimed in claim 15, wherein the accessibility level is a reduced level, increased level, or medium level of accessing the contact.

20. The computer readable storage media as claimed in claim 15, wherein the instructions may be executed to display the contact list on a communication device having a display, monitor, or screen.
